(19) United States
(12) Patent Application Publication
(10) Pub. No.: US 2006/0235135 A1
(43) Pub. Date: Oct. 19, 2006

(54) Resin crystallization promoter and resin composition

(75) Inventors: Tatsuhiro Takahashi, Yamagata (JP); Toshio Morita, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 10/554,063

(22) PCT Filed: Apr. 23, 2004
(86) PCT No.: PCT/JP04/05895

§ 371 Date: Oct. 24, 2005

Related U.S. Application Data
(60) Provisional application No. 60/467,156, filed on May 2, 2003.

(30) Foreign Application Priority Data
Apr. 24, 2003 (JP) 2003-120616

(51) Int. Cl. C08K 3/04

(52) U.S. Cl. 524/496; 423/445 R

(57) ABSTRACT

The present invention relates to a thermoplastic resin crystallization promoter comprising fine carbon fiber consisting of fiber filaments having a diameter of 0.001 μm to 5 μm and an aspect ratio of 5 to 15,000, a thermoplastic resin composition consisting of the fine carbon fiber and thermoplastic resin and comprising crystallized resin, and a production method thereof. The crystallization promoter comprising the fine carbon fiber of the present invention enables to crystallize even an amorphous resin, which has an irregular molecular structure and therefore is not crystallized, or which exhibits low crystallization degree and therefore is difficult to crystallize by means of a conventional crystallization promoter. The crystallization promoter provides a thermoplastic resin composition, which, when molded, exhibits improved strength and tribological characteristics and is further reinforced when mixed with a filler.

### CROSS REFERENCE TO THE RELATED APPLICATIONS

This is an application filed pursuant to 35 U.S.C. Section 111(a) with claiming the benefit of U.S. Provisional application Ser. No. 60/467,156 filed May 2, 2003 under the provision of 35 U.S.C. Section 111(b), pursuant to 35 U.S.C. Section 119(e) (1).

### TECHNICAL FIELD

The present invention relates to an agent for promoting crystallization of a resin (orderly arrangement of polymers around the agent for promoting crystallization). More particularly, the present invention relates to an agent for promoting crystallization of a resin (hereinafter the agent may be referred to as a “resin crystallization promoter”), to a resin composition containing a resin and the resin crystallization promoter, and to a production method thereof.

### BACKGROUND ART

Resins are classified into crystalline resins and amorphous resins, in accordance with their crystallization characteristics. Resins which have a simple, orderly-arranged molecular structure are readily crystallized, and exhibit high crystalline region ratio (high crystallinity) are classified as crystalline resins. Meanwhile, resins which contain a main chain formed of molecular units having different sizes, are irregular in the branching degree of the main chain, and are difficult to crystallize are classified as amorphous resins. Points of distinction between a crystalline resin and an amorphous resin is the presence or absence of melting point attributed to crystallinity other than the glass transition point. Specifically, when a crystalline resin is subjected to differential thermal analysis, an endothermic/exothermic peak is observed in a temperature region higher than the glass transition point of the resin, in addition to a step attributed to heat absorption or heat generation or a step including a peak at the glass transition point. Meanwhile, in an amorphous resin, such an endothermic/exothermic peak is not observed.

Crystalline resins exhibit the characteristic features such as high mechanical strength, excellent fatigue resistance, excellent chemical resistance and excellent tribological characteristics. In addition, among other properties, crystalline resins are highly reinforced when mixed with a filler. Meanwhile, amorphous resins exhibit the characteristic features such as transparency, excellent weather resistance and excellent impact resistance. In addition, amorphous resins are characterized in being readily formed into a product with high dimensional accuracy and having less warpage and sink.

Ease of crystallization differs among acrystalline resins, and some crystalline resins exhibit low crystallization rate attributed to their molecular structure and require a crystallization promoter (nucleating agent) for crystallization. In some cases, a crystallization promoter is added to an easy-to-crystallize crystalline resin in order to regulate its crystallization rate. For example, when a thermoplastic resin is melted and then solidified under cooling, to thereby form a product, the thermal history of a rapidly cooled surface portion of the thus-formed product significantly differs from that of a gradually cooled center portion thereof. Specifically, the surface portion tends to become amorphous because of insufficient crystal growth time, whereas the center portion exhibits high crystallinity because of sufficient crystal growth time; i.e., a skin-core structure is formed in the product. Therefore, mechanical characteristics vary from the surface portion to the center portion. In such a case, the crystallization rate of the thermoplastic resin must be regulated, so that the product exhibits uniform mechanical characteristics. For example, in the case where a resin exhibiting low crystallization rate, such as polyamide-imide, is formed into a product, crystallization of the resin proceeds in the thus-formed product, and shrinkage of the resin occurs, leading to lowered dimensional accuracy of the product. Therefore, the crystallization rate of such a resin must be regulated.

Resin crystallization promoters are roughly classified into inorganic crystallization promoters and organic crystallization promoters. In general, an inorganic crystallization promoter is employed in combination with an organic crystallization promoter.

Examples of inorganic crystallization promoters known hitherto include silica, talc, calcium carbonate, zinc fluoride, cadmium fluoride, titanium dioxide, kaolin, alumina, and amorphous silica-alumina particles.

Examples of organic crystallization promoters known hitherto include fatty acid salts such as stearates (Japanese Patent Application Laid-Open (kokai) No. 47-23446), adipates, and sebacates (Japanese Laid-Open Patent Publication (kokai) No. 50-6650); organic phosphonates such as cyclohexylphosphonates and phenylsulfonates (Japanese Laid-Open Patent Publication (kokai) No. 50-32251); aromatic salts such as benzoic acid (Japanese Patent Application Laid-Open (kokai) No. 53-50251); oligomeric polyesters (Japanese Laid-Open Patent Publication (kokai) No. 55-116751); and a mixture of carbon powder and a compound having a bisimide structure (Japanese Laid-Open Patent Publication (kokai) No. 9-188812).

Resins are intrinsically difficult to crystallize; when a resin is used under customary cooling conditions, the crystallization temperature of the resin varies within a wide range. Therefore, in order to stabilize the shape or physical properties of the resin product, the crystallization temperature or crystallization time of the resin must be regulated by use of a crystallization promoter. However, a conventionally known crystallization promoter fails to fully meet requirements in terms of lowering of crystallization temperature, regulation of crystallization rate, and regulation of the degree of crystallization.

In view of the foregoing, an object of the present invention is to provide a crystallization promoter which enables crystallization of an amorphous resin which has an irregular molecular structure and therefore is not crystallized or exhibits low crystallization degree and therefore is difficult to crystallize by means of a conventional crystallization promoter. As used herein, “crystallization” encompasses not only the state where molecules of the same configuration assume an orderly, three-dimensional periodical arrangement as in the case where molecules are arranged in crystals; but also the state where the structure of polymers around the agent for promoting crystallization is orderly arranged and the state where disorderly arranged molecules of irregular form (amorphous state) is orderly arranged to a certain extent. Another object of the present invention is to provide a thermoplastic resin composition comprising the crystallization promoter, which, when molded, exhibits improved strength and tribological characteristics, and which is further reinforced when mixed with a filler.

The present inventors have found that fine carbon fiber produced through the vapor-growth process, particularly carbon fiber consisting of fiber filaments having a diameter of 0.001 μm to 5 μm and an aspect ratio of 5 to 15,000, serves as an agent for promoting crystallization of an amorphous resin (e.g., polycarbonate), which has been considered difficult to crystallize, and the fine carbon fiber also promotes crystallization (the rate and degree of crystallization) of a crystalline resin which can be crystallized but exhibits low crystallization rate and low crystallization degree. The present invention has been accomplished on the basis of this finding.

Accordingly, the present invention provides a resin crystallization promoter, a production method thereof, a resin composition comprising the crystallization promoter and use thereof, as described below.

1. A resin crystallization promoter comprising fine carbon fiber, each fiber filament of the carbon fiber having a diameter of 0.001 μm to 5 μm and an aspect ratio of 5 to 15,000.

2. The resin crystallization promoter according to 1 above, wherein the fine carbon fiber is vapor grown carbon fiber.

3. The resin crystallization promoter according to 2 above, wherein the vapor grown carbon fiber contains boron in an amount of 0.001 to 5 mass %.

4. A resin composition comprising a resin crystallization promoter as recited in any of 1 through 3 above, and a resin.

5. The resin composition according to 4 above, wherein the resin is a thermoplastic resin.

6. The resin composition according to 5 above, wherein the thermoplastic resin is an amorphous thermoplastic resin.

7. The resin composition according to 5 or 6 above, wherein the thermoplastic resin is a resin containing a polymer including a structural unit having an aromatic group as a repeating unit.

8. The resin composition according to 5 above, wherein the thermoplastic resin is any species selected among polystyrene, polycarbonate, polyarylate, polysulfone, polyetherimide, polyethylene terephthalate, polyphenylene oxide, polyphenylene sulfide, polybutylene terephthalate, polyimide, polyamide-imide and polyether-ether-ketone; or a mixture thereof.

9. The resin composition according to any of 4 through 8 above, which, when subjected to differential scanning calorimetry (DSC), exhibits an endothermic/exothermic peak which is not associated with change in mass at a temperature other than the glass transition point of the resin.

10. The resin composition according to any of 4 through 8 above, which, when subjected to differential scanning calorimetry (DSC), exhibits an endothermic/exothermic peak attributed to melting or crystallization of the composition, wherein the peak is higher or the peak shifts to a higher temperature region, as compared with the case of a resin composition which does not contain the resin crystalline promoter as recited in any of 1 through 3 above.

11. The resin composition according to any of 4 through 8 above, which, when subjected to X-ray diffractometry, exhibits a peak attributed to the resin, and a peak attributed to orderly arrangement of a resin structure.

12. The resin composition according to any of 4 through 8 above, wherein, in X-ray diffractometry, the half width of the band of the diffraction angle (20) corresponding to a peak attributed to orderly arrangement of a resin structure is 5° or less.

13. The resin composition according to any of 4 through 12 above, wherein the content of the resin crystallization promoter is 0.1 to 80 mass %.

14. A method for producing a resin composition having a crystallized and orderly arranged structure, characterized by comprising kneading the crystallization promoter as recited in 1 or 2 above with a resin, and subsequently subjecting the resultant mixture to annealing at a temperature equal to or higher than the glass transition point of the resin.

15. An electrically conductive material comprising the resin composition as recited in any of 4 through 13 above.

16. A thermally conductive material comprising the resin composition as recited in any of 4 through 13 above.

17. A material exhibiting tribological characteristics comprising the resin composition as recited in any of 4 through 13 above.

18. A mechanism part comprising the resin composition as recited in any of 4 through 13 above.

The crystallization promoter of the present invention contains fine carbon fiber, each fiber filament of the carbon fiber having a diameter of 0.001 μm to 5 μm and an aspect ratio of 5 to 15,000. Examples of such carbon fiber include vapor grown carbon fiber which is produced by feeding a gasified organic compound into a high-temperature atmosphere together with iron serving as a catalyst (see Japanese Patent No. 2778434). The present invention preferably employs such vapor grown carbon fiber.

The vapor grown carbon fiber to be employed may be, for example, “as-produced” carbon fiber; carbon fiber obtained through thermal treatment of “as-produced” carbon fiber at 800 to 1,500° C.; or carbon fiber obtained through graphitization of “as-produced” carbon fiber at 2,000 to 3,000° C. Preferably, carbon fiber which has undergone graphitization at 1,500° C. or higher or at 2,000 to 3,000C is employed.

The vapor grown carbon fiber may be vapor grown carbon fiber which has been graphitized in the presence of an element which promotes carbon crystallization such as B, Al, Be or Si (preferably boron) such that a small amount (0.001 to 5 mass %, preferably 0.01 to 2 mass %) of the element is contained in carbon crystals of the resultant vapor grown carbon fiber (WO 00/585326).

The vapor grown carbon fiber which has undergone such high-temperature treatment has an interlayer distance (i.e., an indicator for evaluating carbon crystallinity) of 0.68 nm or less, and the surface structure of the vapor grown carbon fiber becomes closer to a graphite structure, as compared with the case of the vapor grown carbon fiber which has undergone thermal treatment at 800 to 1,500° C. Therefore, when the thus-graphitized vapor grown carbon fiber is added to a thermoplastic resin, conceivably, interaction between the surface of the carbon fiber and the resin tends to occur, thereby promoting crystallization of the resin.

The amount of the fine carbon fiber to be added to a thermoplastic resin varies in accordance with use of the resultant resin composition. The amount of the fine carbon fiber is generally 0.1 to 80 mass %, preferably 1 to 80 mass %, more preferably about 5 to about 60 mass %, on the basis of the entirety of the thermoplastic resin. When the amount of the fine carbon fiber is less than 0.1 mass %, the effects of the carbon fiber fail to be obtained, whereas when the amount of carbon fiber exceeds 80 mass %, difficulty is encountered in mixing the fine carbon fiber with the thermoplastic resin.

Preferably, the vapor grown carbon fiber is uniformly mixed with a thermoplastic resin. Therefore, the vapor grown carbon fiber must be melt-mixed with the thermoplastic resin.

No particular limitations are imposed in the melt-mixing method, and the method may employ, for example, a twin-screw extruder, a planetary gear shaker, or a modified screw barrel such as a co-kneader.

In the present invention, thermoplastic resins for which the fine carbon fiber is incorporated to thereby induce crystallization of resin or promote crystallization of resin include both crystalline resins and amorphous resins.

No particular limitations are imposed on the crystalline resin whose crystallization is promoted, but the resin is preferably a crystalline resin containing a polymer including a structural repeating unit having an aromatic group. The term “aromatic group” refers to a group containing a heterocyclic ring, a benzene ring, or a condensed ring such as naphthalene and anthracene. Examples of the aromatic group include monovalent groups such as pyridyl, quinazolinyl, anilino, phenyl, alkyl-substituted phenyl, naphthyl and biphenylyl; and divalent groups such as pyridinediyl, phenylene, naphthylene, biphenylene and acenaphthylene. Phenyl, alkyl-substituted phenyl, phenylene and biphenylene are preferred. Preferred examples of the crystalline thermoplastic resin include polyethylene terephthalate (PET), polyphenylene sulfide (PPS) and polybutylene terephthalate (PBT). The crystallization promoter of the present invention containing the fine carbon fiber effectively promotes crystallization of a resin which is difficult to crystallize under generally employed conditions; in particular, polyethylene terephthalate, polyphenylene sulfide, etc. By means of the crystallization promoter, the crystallization rate of such a resin is regulated, and thus characteristic features of the resin, including mechanical strength, fatigue resistance, chemical resistance and tribological characteristics, can be effectively obtained.

Examples of the amorphous resin which can be crystallized by means of the crystallization promoter of the present invention comprising the fine carbon fiber include polystyrene, polycarbonate (PC), polyarylate (PAR), polysulfone, polyetherimide, polyamide-imide, modified polyphenylene oxide and polyimide. In general, such a resin is not crystallized even when a crystallization promoter is added thereto. However, by using the vapor grown carbon fiber of the present invention, the resin can be crystallized by means of interaction between the resin and the vapor grown carbon fiber.

For example, polycarbonate is crystallized through the following procedure: vapor grown carbon fiber which has undergone thermal treatment at 2,800° C. (fiber filaments of the carbon fiber having an average diameter of 0.15 μm and an aspect ratio of 70) (5 mass %) is added to and melt-kneaded with polycarbonate; the resultant mixture is molded into a product by use of a thermal press; the thus-molded product is subjected to annealing for two hours at 200° C.; i.e., at a temperature 90 degrees lower than 290° C., which is a generally employed molding temperature; and, immediately after the annealing, the resultant product is immersed in a water bath for quenching. The degree of crystallization of the resin can be measured by means of chemical techniques; for example, (1) measurement of density, (2) X-ray diffraction intensity of a crystalline region and an amorphous region, (3) intensity of infrared adsorption band of a crystalline region or an amorphous region, (4) differential curve of wide-line nuclear magnetic resonance absorption spectrum, (5) measurement of heat of melting, and (6) adsorption of moisture or hydrolysis-oxidation. However, the value of the crystallization degree of the resin varies in accordance with the measurement method, since a semi-crystalline region is present between a crystalline region and an amorphous region of the resin, which is difficult to determine to be either. Crystallization of the resin can be confirmed by measuring heat of melting by use of, for example, a differential scanning calorimeter (DSC). The transition temperature of the resin can be measured by means of, for example, the following methods: the method specified by JIS K7121 in which the resin is subjected to a predetermined thermal treatment and then cooled, followed by measurement of the transition temperature; or a method in which the resin (sample) is heated and melted. For example, when the transition temperature of the resin is measured by use of a DSC, an endothermic/exothermic peak attributed to change in phase which is not associated with change in mass is observed in the vicinity of 200° C., which is higher than the glass transition point (Tg) in the vicinity of 150° C. (see FIG. 2). Annealing (thermal treatment) of the resin is performed mainly to eliminate strain inside the polymer, to promote crystallization of the resin and to improve long-term stability of the resin.

Such an endothermic/exothermic peak corresponds to the melting point (Tm) of a crystalline thermoplastic resin. Therefore, conceivably, occurrence of the above-observed endothermic/exothermic peak is attributed to crystallization of the amorphous resin by means of the crystallization promotion effect of the vapor grown carbon fiber.

In the case of an amorphous methacrylic resin which does not contain a polymer including a structural repeating unit having an aromatic group, even when the resin is subjected to annealing at a temperature lower than the molding temperature in a manner similar to that described above, no peak is observed in a temperature region higher than the glass transition point (Tg) of the resin.

Crystallization of a crystalline resin is promoted by means of the crystallization promotion effect of the vapor grown carbon fiber. This crystallization promotion can be confirmed by the following phenomenon: the endothermic or exothermic peak corresponding to Tm of the resin, which is obtained through DSC measurement, shifts to a higher temperature region; or the peak corresponding to Tm of the resin becomes higher.

Crystallization of the resin composition of the present invention can be confirmed by means of X-ray diffractometry performed at a temperature equal to or lower than the melting temperature of the composition. A peak attributed to orderly arrangement of a resin structure, which is shaper than a peak attributed to a disorderly arranged resin structure, is obtained through X-ray diffractometry, and the former peak coexists with the latter peak. The half width of the band of the diffraction angle (20) measured by X-ray diffractometry of the peak attributed to orderly arrangement of a resin structure is 5° or less, preferably 0.5 to 5°, more preferably 0.5 to 4°.

Conceivably, crystallization of the resin composition is promoted by means of interaction between the surface of vapor grown carbon fiber and an amorphous thermoplastic resin containing a polymer including a structural repeating unit having an aromatic group. FIG. 1 shows a transmission electron micrograph of a fiber filament of vapor grown carbon fiber which has undergone thermal treatment (graphitization) at 2,800° C., fiber filaments of the carbon fiber having an average diameter of 0.15 μm and an aspect ratio of 70. As shown in FIG. 1, the surface of the fiber filament contains short graphite crystals of irregular structure as a result of incomplete development of graphite crystals. Conceivably, interaction between the disordered portion of crystalline carbon and the amorphous thermoplastic resin causes crystallization of the thermoplastic resin.

The thermoplastic resin composition of the present invention containing the vapor grown carbon fiber serving as the crystallization promoter, which composition exhibits an endothermic/exothermic peak at a temperature other than the glass transition point of the matrix resin, an increased endothermic/exothermic peak corresponding to the melting point of the resin, or a high-temperature-region-shifted endothermic/exothermic peak corresponding to the melting point of the resin, can be employed as an electrically conductive material or a thermally conductive material by regulating the amount of the vapor grown carbon fiber. When the amount of the vapor grown carbon fiber contained in the composition or the cooling rate of the composition is regulated, the degree or rate of crystallization of the composition can be controlled, whereby characteristics of the composition, including mechanical strength, fatigue resistance and tribological characteristics, can be improved.

The resin composition of the present invention may contain an additive such as a flame retardant, an impact resistance-improving agent, an antistatic agent, a slipping agent, an anti-blocking agent, a lubricant, an anti-fogging agent, natural oil, synthetic oil, wax, an organic filler and an inorganic filler, so long as the additive does not impede the purposes of the present invention.

The resin composition of the present invention can be employed for producing mechanism parts for electric devices, electronic devices, optical devices, automobiles, OA devices, etc.; materials exhibiting tribological characteristics; and housings.

### BRIEF DESCRIPTION OF THE DRAWINGS

FIG. 1 is a transmission electron micrograph of a fiber filament of vapor grown carbon fiber which has undergone thermal treatment (graphitization) at 2,800° C., fiber filaments of the carbon fiber having an average diameter of 0.15 μm and an aspect ratio of 70.

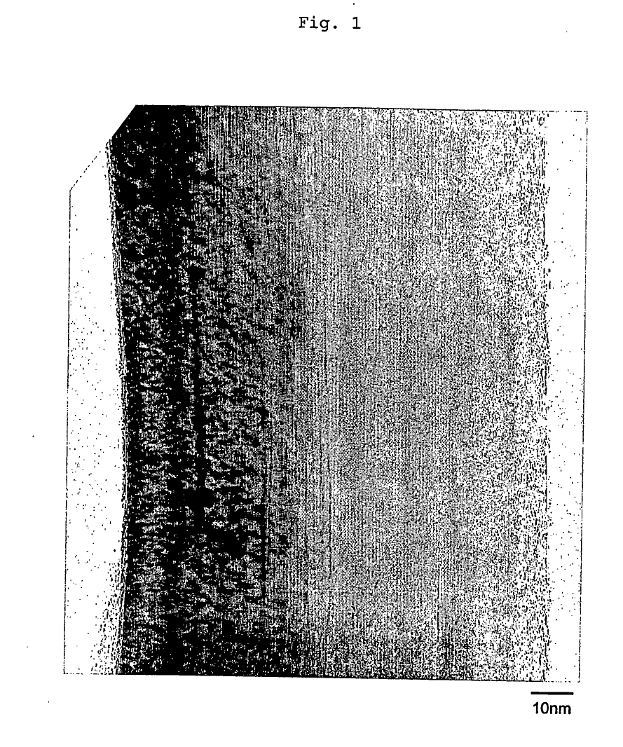

FIG. 2 shows DSC curves of the test samples formed from a composition of Example 1 prepared by kneading polycarbonate (PC) with vapor grown carbon fiber (VGCF) (annealing temperature: 180° C., 200° C., 220° C.); and DSC curves of the test samples formed from a composition of Comparative Example 1 (annealing temperature: 160° C., 240° C.).

FIG. 3 shows X-ray diffraction interference curves of the test samples formed from the compositions of Example 1 and Comparative Example 1 prepared by kneading polycarbonate (PC) with vapor grown carbon fiber (VGCF).

FIG. 4 shows DSC curves of the test samples formed from a composition of Example 4 prepared by kneading polycarbonate (PC) with vapor grown carbon fiber (VGCF).

FIG. 5 shows X-ray diffraction interference curves of the test samples formed from the composition of Example 4 prepared by kneading polycarbonate (PC) with vapor grown carbon fiber (VGCF).

FIG. 6 shows DSC curves of the test samples formed from polycarbonate (PC) employed in Comparative Example 3.

FIG. 7 shows X-ray diffraction interference curves of the test samples formed from polycarbonate (PC) employed in Comparative Example 3.

### BEST MODE FOR CARRYING OUT THE INVENTION

The present invention will next be described with reference to Examples and Comparative Examples, but the present invention is not limited to the Examples described below.

### EXAMPLE 1

Polycarbonate (PC; AD5503, product of Teijin Chemicals Ltd., average molecular weight: 20,000, mass average molecular weight: 32,000) was dried under vacuum (20 Torr) at 120° C. for 24 hours. By use of Labo Plastomill, the resultant polycarbonate was kneaded with vapor grown carbon fiber (VGCF; registered trademark, product of Showa Denko K. K.) which had undergone thermal treatment at 2,800° C. (average diameter of fiber filaments of the carbon fiber: 0.15 am, aspect ratio of the fiber filaments: 70) at a ratio by mass of 95:5, to thereby form a plate of 100 mm×100 mm×2 mmt.

The thus-formed plate was subjected to annealing for two hours at a temperature of 180° C., 200° C. or 220° C. Immediately after annealing, the resultant plate was immersed in a water bath.

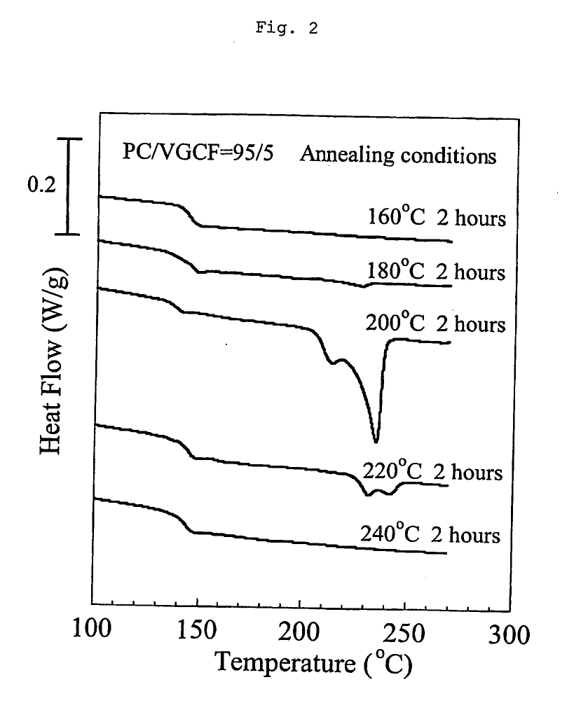

A test piece was prepared from the plate, and the test piece was subjected to differential thermal analysis by use of a differential scanning calorimeter (DSC; SSC5200, product of Seiko Instruments Inc.; temperature increasing rate: 10 deg/min). The results are shown in FIG. 2. Endothermic peaks attributed to Tg and Tm were observed at about 150° C. and at 200 to 250° C., respectively.

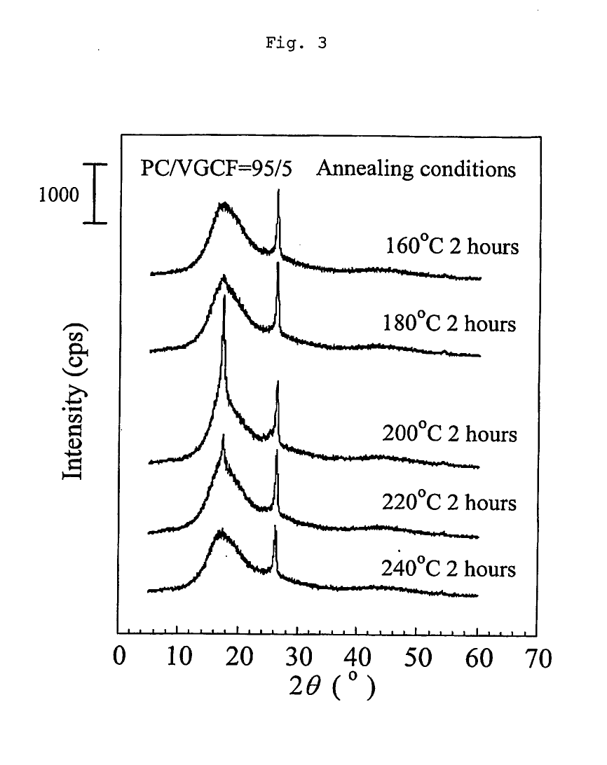

The test piece was subjected to X-ray analysis by use of an X-ray diffraction apparatus (RAD-B, product of Rigaku Corporation). FIG. 3 shows the resultant interference curve. A peak attributed to a disordered structure of polycarbonate was observed at a diffraction angle (2θ) of 12 to 24°, and a peak attributed to a polycarbonate structure which had been orderly arranged by means of the VGCF (registered trademark) was observed at a diffraction angle (20) of 26 to 28°. These peaks were found to coexist with each other.

The test piece prepared from the plate which had undergone annealing at 200° C. was subjected to measurement in terms of thermal conductivity, bending strength, flexural modulus and kinetic friction coefficient by means of the below-described methods. The results are shown in Table 1.

Thermal Conductivity:

Measured by the method specified by ASTM C-177 or the heat wire method.

Bending Strength:

Measured by the method specified by ASTM D-790.

Flexural Modulus:

Measured by the method specified by ASTM D-790.

Kinetic Friction Coefficient:

Measured by the continuous sliding wear test specified by JIS K 7218, in which the test piece is worn by bringing it into contact with the end face of the hollow cylinder (load: 2 kgf/cm², opposite material: S45C steel).

### COMPARATIVE EXAMPLE 1

A plate was prepared in a manner similar to that of Example 1, and the plate was subjected to annealing for two hours at a temperature of 160° C. or 240° C. In a manner similar to that of Example 1, a test piece prepared from the resultant plate was subjected to DSC measurement and X-ray diffraction analysis. The results are shown in FIGS. 2 and 3 (the uppermost and lowermost curves in the respective figures) together with the results of Example 1. A new peak attributed to crystallization of polycarbonate was not observed.

### EXAMPLE 2 AND COMPARATIVE EXAMPLE 2

Thermoplastic polyimide (PI; Aurum 400, product of Mitsui Chemicals, Inc.) (95 mass %) was melt-mixed with 5 mass % of VGCF (registered trademark), to thereby prepare a sample. The sample was maintained in a DSC apparatus under a nitrogen stream (50 ml/min) at 400° C. for 10 minutes, and then subjected to DSC measurement under cooling conditions (cooling rate: 5 degrees/min). As a result, a peak attributed to crystallization (Tc) of the polyimide was observed at 358° C. When the sample was maintained in a DSC at 370° C., and then subjected to isothermal crystallization measurement, the time elapsed until a peak attributed to the crystallization was observed was found to be 195 seconds.

In Comparative Example 2, a sample was prepared merely from the thermoplastic polyimide without adding VGCF (registered trademark) and subjected to DSC measurement in a manner similar to that described above. As a result, a peak attributed to crystallization (Tc) of the polyimide was observed at 356° C., and the time elapsed until the peak attributed to the crystallization was observed was found to be 256 seconds.

Fundamental characteristics (thermal conductivity, bending strength, flexural modulus and kinetic friction coefficient) as resin composite material of the above-prepared sample were measured in a manner similar to that of Example 1. The results are shown in Table 1.

### EXAMPLE 3

A sample was prepared by use of VGCF (registered trademark) containing 0.1 mass % boron instead of the VGCF (registered trademark) employed in Example 1, and the sample was subjected to annealing at 200° C. for two hours. In a manner similar to that of Example 1, the sample was subjected to DSC measurement and X-ray diffraction analysis. Peaks similar to those observed in the case of Example 1 were observed.

### EXAMPLE 4

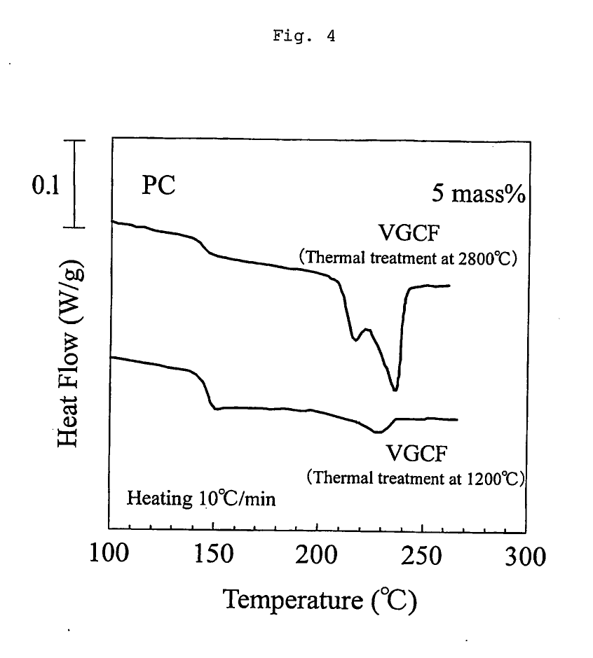

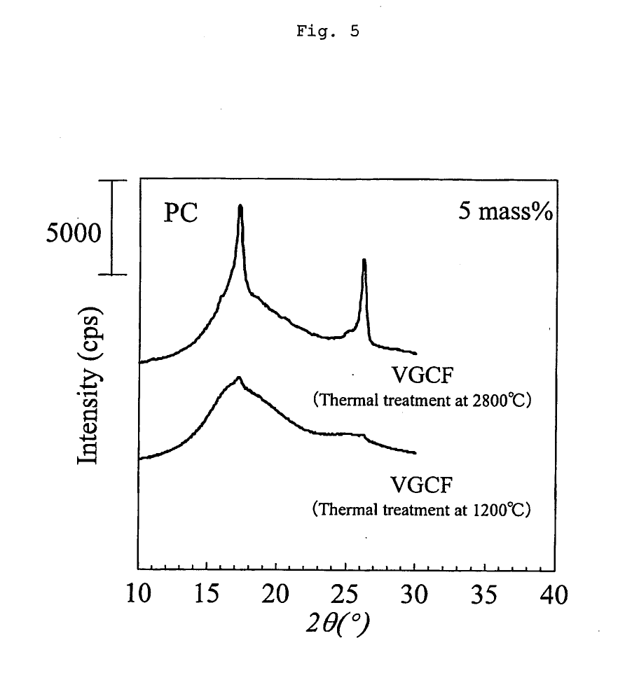

A sample was prepared by use of VGCF (registered trademark) which had undergone thermal treatment at 1,200° C. instead of the VGCF employed in Example 1, and the sample was subjected to annealing at 200° C. for two hours. In a manner similar to that of Example 1, the sample was subjected to DSC measurement and X-ray diffraction analysis. The results are shown in FIGS. 4 and 5. For comparison, the measurement results of the sample of Example 1, which sample was prepared by use of the VGCF which had undergone thermal treatment at 2,800° C. and was subjected to annealing, are also shown in FIGS. 4 and 5.

### COMPARATIVE EXAMPLE 3

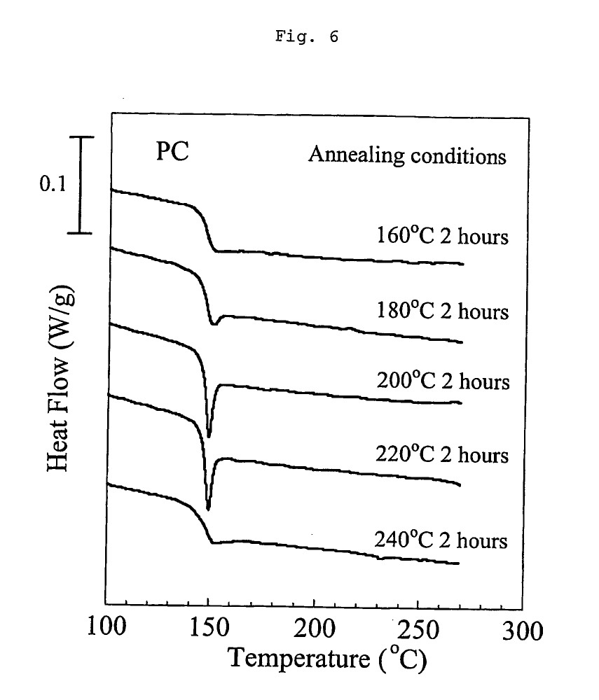

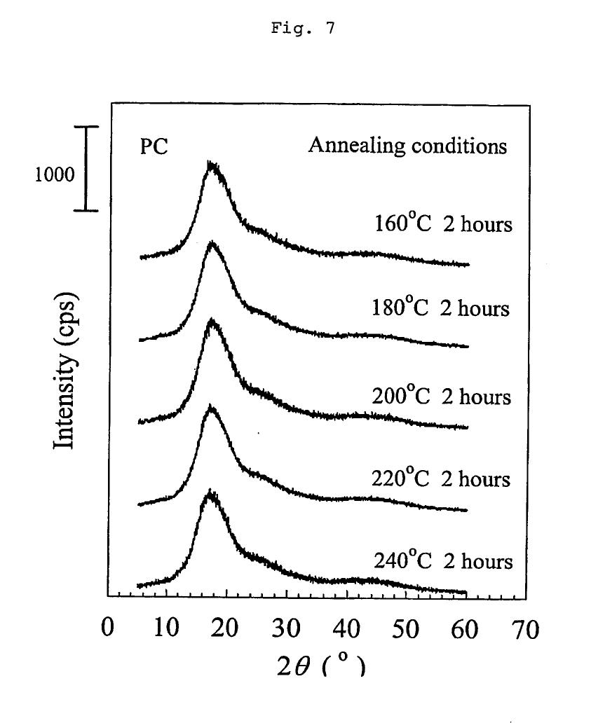

The procedure of Example 1 was repeated, except that the VGCF (registered trademark) was not employed, to thereby prepare a plate sample. The plate sample was subjected to annealing for two hours at a temperature of 160° C., 180° C., 200° C., 220° C. or 240° C. The resultant sample was subjected to DSC measurement and X-ray diffraction analysis in a manner similar to that of Example 1. The results are shown in FIGS. 6 and 7. A new peak attributed to crystallization of the polycarbonate was not observed.

### COMPARATIVE EXAMPLES 4 AND 5

Polymethyl methacrylate (PMMA; 60N, product of Asahi Kasei Corporation, number average molecular weight: 76,000, mass average molecular weight: 150,000) was dried under vacuum (20 Torr) at 80° C. for 24 hours. By use of Labo Plastomill, the resultant polymethyl methacrylate was kneaded with vapor grown carbon fiber (VCGF, registered trademark) which had undergone thermal treatment at 2,800° C. (diameter of fiber filaments of the carbon fiber: 0.15 μm, aspect ratio of the fiber filaments: 70) at a ratio by mass of 95 : 5, to thereby form a plate of 100 mm×100 mm×2 mmt.

The thus-formed plate was subjected to annealing at 150° C. for two hours. Immediately after annealing, the resultant plate was immersed in a water bath.

A test piece was prepared from the plate, and the test piece was subjected to differential thermal analysis by use of a differential scanning calorimeter (DSC; SSC 5200, product of Seiko Instruments Inc.; temperature increasing rate: 10 deg/min) (Comparative Example 4). In Comparative Example 5, a test piece was prepared merely from the polymethyl methacrylate without adding VGCF (registered trademark). The resultant test piece was subjected to DSC measurement in a manner similar to that described above. As a result, in the DSC measurement, Tg was observed at about 100° C., but no endothermic peak was observed. In a manner similar to that of Example 1, the test piece was subjected to measurement in terms of thermal conductivity, bending strength, flexural modulus and kinetic friction coefficient. The results are shown in Table 1.

TABLE 1

| | | | | Volume | Thermal | Bending | Flexural | |
|---|---|---|---|---|---|---|---|---|
| | | Tg | Tm or Tc | resistivity | conductivity | strength | modulus | Kinetic friction |
| | Composition | (° C.) | (° C.) | (Ω · cm) | (W/mk) | (Mpa) | (Gpa) | coefficient |
| Example 1 | PC + VGCF | 145 | Tm = 232 | 10⁸ | 0.39 | 91 | 2.2 | 0.30 |
| | (5 mass %) | | | | | | | |
| Example 2 | PI + VGCF | 251 | Tc = 358 | 10⁸ | 0.29 | 98 | 2.5 | 0.12 |
| | (5 mass %) | | | | | | | |
| Comparative | PI | 251 | Tc = 356 | >10¹⁴ | 0.28 | 96 | 2.4 | 0.12 |
| Example 2 | | | | | | | | |
| Comparative | PC | 145 | Not | >10¹⁴ | 0.25 | 90 | 1.0 | 0.33 |
| Example 3 | | | detected | | | | | |
| Comparative | PMMA + VGCF | 97 | Not | 10⁸ | 0.37 | 104 | 1.8 | 0.28 |
| Example 4 | (5 mass %) | | detected | | | | | |
| Comparative | PMMA | 97 | Not | >10¹⁴ | 0.23 | 104 | 0.9 | 0.27 |
| Example 5 | | | detected | | | | | |

### INDUSTRIAL APPLICABILITY

Fine carbon fiber; for example, vapor grown carbon fiber, each fiber filament of the carbon fiber having a diameter of 0.001 μm to 5 μm and an aspect ratio of 5 to 15, 000, serves as a resin crystallization promoter. When the crystallization promoter of the present invention is added to a resin (e.g., a thermoplastic resin), rate and degree of the crystallization of the resin can be regulated, whereby characteristics of the resin can be varied. Therefore, the resultant resin composition is suitable for use in mechanism parts or materials exhibiting tribological characteristics.

1. A resin crystallization promoter comprising fine carbon fiber, each fiber filament of the carbon fiber having a diameter of 0.001 μm to 5 μm and an aspect ratio of 5 to 15,000.

2. The resin crystallization promoter as claimed in claim 1, wherein the fine carbon fiber is vapor grown carbon fiber.

3. The resin crystallization promoter as claimed in claim 2, wherein the vapor grown carbon fiber contains boron in an amount of 0.001 to 5 mass %.

4. A resin composition comprising a resin crystallization promoter as claimed in claim 1, and a resin.

5. The resin composition as claimed in claim 4, wherein the resin is a thermoplastic resin.

6. The resin composition as claimed in claim 5, wherein the thermoplastic resin is an amorphous thermoplastic resin.

7. The resin composition as claimed in claim 5, wherein the thermoplastic resin is a resin containing a polymer including a structural unit having an aromatic group as a repeating unit.

8. The resin composition as claimed in claim 5, wherein the thermoplastic resin is any species selected among polystyrene, polycarbonate, polyarylate, polysulfone, polyetherimide, polyethylene terephthalate, polyphenylene oxide, polyphenylene sulfide, polybutylene terephthalate, polyimide, polyamide-imide and polyether-ether-ketone; or a mixture thereof.

9. The resin composition as claimed in claim 4, which, when subjected to differential scanning calorimetry (DSC), exhibits an endothermic/exothermic peak which is not associated with change in mass at a temperature other than the glass transition point of the resin.

10. The resin composition as claimed in claim 4, which, when subjected to differential scanning calorimetry (DSC), exhibits an endothermic/exothermic peak attributed to melting or crystallization of the composition, wherein the peak is higher or the peak shifts to a higher temperature region, as compared with the case of a resin composition which does not contain the resin crystalline promoter.

11. The resin composition as claimed in claim 4, which, when subjected to X-ray diffractometry, exhibits a peak attributed to the resin, and a peak attributed to orderly arrangement of a resin structure.

12. The resin composition as claimed in claim 4, wherein, in X-ray diffractometry, the half width of the band of the diffraction angle (2θ) corresponding to a peak attributed to orderly arrangement of a resin structure is 5° or less.

13. The resin composition as claimed in claim 4, wherein the content of the resin crystallization promoter is 0.1 to 80 mass %.

14. A method for producing a resin composition having a crystallized and orderly arranged structure, characterized by comprising kneading the crystallization promoter as claimed in claim 1 with a resin, and subsequently subjecting the resultant mixture to annealing at a temperature equal to or higher than the glass transition point of the resin.

15. An electrically conductive material comprising the resin composition as claimed in claim 4.

16. A thermally conductive material comprising the resin composition as claimed in claim 4.

17. A material exhibiting tribological characteristics comprising the resin composition as claimed in claim 4.

18. A mechanism part comprising the resin composition as claimed in claim 4.
